(19) United States
(12) Patent Application Publication
(10) Pub. No.: US 2009/0242847 A1
(43) Pub. Date: Oct. 1, 2009

(54) DISPLAY PARTICLES FOR IMAGE DISPLAY APPARATUS AND IMAGE DISPLAY APPARATUS

(75) Inventors: Yukio HOSOYA, Tama-shi (JP); Okushi OKUYAMA, Hachioji-shi (JP); Satoshi UCHINO, Hino-shi (JP); Hiroyuki KONNO, Hachioji-shi (JP); Tatsuya NAGASE, Tachikawa-shi (JP); Shigeki TAKENOUCHI, Chofu-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/406,321

(22) Filed: Mar. 18, 2009

(30) Foreign Application Priority Data
Mar. 31, 2008 (JP) 2008-090332

(51) Int. Cl. H01B 1/12

(52) U.S. Cl. 252/500

(57) ABSTRACT

Display particles, which are used for an image display apparatus having a structure in which the display particles in a powdered state are sealed between two substrates at least one of which is transparent, and by generating an electric field between the substrates, the display particles are moved so that an image is displayed, comprising: base particles A containing at least a resin and a colorant, and having a volume-average particle size D1 of 1 to 50 μm; resin fine particles B being externally added to the base particles, and having an average primary particle size D2 of 30 to 250 nm; and inorganic fine particles C being externally added to the base particles, and having an average primary particle size D3 of 5 to 30 nm, wherein the display particles for an image display apparatus are designed so that D1, D2 and D3 satisfy 10≦D1/D2≦1000 and 2≦D2/D3≦50, and an image display apparatus provided with such particles for an image display apparatus.

This application is based on application(s) No. 2008-090332 filed in Japan, the contents of which are hereby incorporated by reference.

### TECHNICAL FIELD

The present invention relates to an image display apparatus capable of displaying and erasing images repeatedly by moving display particles in an electric field, and to display particles to be used in the image display apparatus.

### BACKGROUND ART

Conventionally, an image display apparatus has been known in which an image is displayed by moving display particles in a gaseous phase. This image display apparatus has a structure in which the display particles in a powdered state are sealed between two substrates at least one of which is transparent, and by generating an electric field between the substrates, the display particles are moved and adhered to one of the substrates so that an image is displayed. Upon driving such an image display apparatus, a voltage is applied between the substrates to generate an electric field so that the display particles are moved in the electric field direction; therefore, by selecting appropriately the direction of the electric field, a displaying operation and an erasing operation of an image can be carried out repeatedly. For this reason, in the image display apparatus, there have been demands for moving the display particles smoothly even under a low driving voltage.

However, once the display particles have been adhered to the substrate, the adhesive strength is comparatively strong; therefore, in an attempt to carry out image displaying and erasing operations repeatedly, a high voltage has to be applied between the substrates so as to separate the adhered display particles therefrom. When the number of display particles that have been left adhered to the substrate surface increases, the density of a display image is lowered to cause a reduction in the contrast of the image and affect in the image quality. These problems of an increase in the driving voltage and a reduction in the contrast tend to become conspicuous as the image display apparatus is used repeatedly.

Consequently, in order to reduce the adhesive strength between the display particles and the substrate, a technique has been known in which fine particles of silica, titanium oxide or the like, having, for example, an average primary particle size of 5 to 50 nm, are externally added to the display particles (for example, Patent Literature 1.

Citation List

Patent Literature 1: Japanese Patent Laid-Open No. 2004-29699

### SUMMARY OF INVENTION

### Technical Problem

However, the above-mentioned technique cannot provide a sufficient adhesive strength-reducing effect, resulting in a failure to sufficiently achieve a low-voltage operation (100V or less).

An object of the present invention is to provide display particles for an image display apparatus that can display an image having comparatively high contrast repeatedly even when a driving voltage is comparatively low, and an image display apparatus provided with such display particles.

### Solution to Problem

The present invention provides to display particles, which are used for an image display apparatus having a structure in which the display particles in a powdered state are sealed between two substrates at least one of which is transparent, and by generating an electric field between the substrates, the display particles are moved so that an image is displayed, include:

base particles A containing at least a resin and a colorant, and having a volume-average particle size D1 of 1 to 50 μm;

resin fine particles B being externally added to the base particles, and having an average primary particle size D2 of 30 to 250 nm; and

inorganic fine particles C being externally added to the base particles, and having an average primary particle size D3 of 5 to 30 nm, in which the display particles for an image display apparatus are designed so that D1, D2 and D3 satisfy the following formulae:

10≦D1/D2≦1000 (1)

2≦D2/D3≦50 (2)

and to an image display apparatus provided with such display particles.

### ADVANTAGEOUS EFFECTS OF INVENTION

In accordance with the present invention, since an adhesive strength-reducing effect is improved by fine particles (external additives) to be externally added to the display particles, it becomes possible to display an image having comparatively high contrast repeatedly even when a driving voltage is comparatively low.

### BRIEF DESCRIPTION OF DRAWINGS

FIG. 1 is a schematic view showing one example of display particles for an image display apparatus.

FIG. 2 is a schematic view showing one example of a cross-sectional structure of the image display apparatus.

FIG. 3 is a schematic view showing an example of movements of the display particles upon application of a voltage between substrates.

FIG. 4 is a schematic view showing an example of movements of the display particles upon application of a voltage between substrates.

FIG. 5 is a schematic view showing an example of a shape of an image display surface.

FIG. 6 is a schematic view showing one example of a sealing method for the display particles.

### DESCRIPTION OF EMBODIMENTS

The present invention relates to display particles, which are used for an image display apparatus having a structure in which the display particles in a powdered state are sealed between two substrates at least one of which is transparent, and by generating an electric field between the substrates, the display particles are moved so that an image is displayed, include:

base particles A containing at least a resin and a colorant, and having a volume-average particle size D1 of 1 to 50 μm;

resin fine particles B being externally added to the base particles, and having an average primary particle size D2 of 30 to 250 nm; and

inorganic fine particles C being externally added to the base particles, and having an average primary particle size D3 of 5 to 30 nm, in which the display particles for an image display apparatus are designed so that D1, D2 and D3 satisfy the following formulae:

10≦D1/D2≦1000 (1)

2≦D2/D3≦50 (2)

and to an image display apparatus provided with such display particles.

Display Particles for an Image-Forming Apparatus

Display particles for an image-display apparatus (hereinafter, referred to simply as “display particles”) according to the present invention contain base particles A, resin fine particles B and inorganic fine particles C, and specifically resin fine particles B and inorganic fine particles C are externally added to base particles A. Impurities may be contained as far as the effects of the present invention are not ruined. The display particles normally contain positively charged display particles and negatively charged display particles, and each of the display particles has the structure in which resin fine particles B and inorganic fine particles C are externally added to base particles A. The positively charged display particles and the negatively charged display particles are charged to predetermined polarities by, for example, being made in friction-contact with each other, or by being made in friction-contact with a reference material such as iron particles (carrier) serving as a charge-applying material. The charging polarities can be controlled by, for example, the kinds of a resin and a charge-controlling agent to be contained in the base particle or the kinds of an external additive to be externally added thereto, or the like.

The base particles play following roles.

(1) The base particles contain a colorant and have an appropriate size, and thereby function to express color for display.

(2) The base particles have been electrical charged and move by Coulomb force caused by an applied electrical field. Thereby, the base particles function to change the display color.

(3) The base particles have an appropriate adhesive strength (Van der Waals force+liquid cross-linking force+image force). Thereby, the base particles function to keep the display color as they are when the power supply is turned off.

Base particles A are colored resin particles containing at least a resin and a colorant, and different colored colorants are contained between base particles A1 contained in the positively charged display particles and base particles A2 contained in the negatively charged display particles. When simply referred to as base particles A, this means the base particles A1 as well as the base particles A2 inclusively.

The term “different colors” means that, when an electric field is generated between substrates in an image-displaying apparatus that will be described later, a displayed image can be visually recognized by differences such as in color phase, brightness and chromaticness between display particles that are moved and allowed to adhere onto the substrate on the upstream side in the visually recognizing direction and display particles that are left and allowed to adhere onto the substrate on the downstream side in the visually recognizing direction. For example, white-color base particles and black-color base particles are used in combination.

The colors can be controlled by the kinds of the colorant contained in the base particles (black: carbon black, iron oxide, and aniline black; white: titanium oxide, zinc oxide, and zinc sulfide).

The resin that forms the base particles A is not particularly limited, and typical examples thereof are the following polymers referred to as vinyl-based resins, and in addition to the vinyl-based resins, condensation-type resins, such as a polyamide resin, a polyester resin, a polycarbonate resin and an epoxy resin may be included. Specific examples of the vinyl-based resins include a polystyrene resin, a polyacrylic resin and a polymethacrylic resin, and in addition to these, a polyolefin resin formed by an ethylene monomer and a propylene monomer or the like may be included. As resins other than the vinyl-based resin, in addition to the condensation-type resins, a polyether resin, a polysulfone resin, a polyurethane resin, a fluorine-based resin, a silicone-based resin and the like may be included.

The polymer constituting a resin that is usable for the base particles A may be obtained by using at least one kind of polymerizable monomers that form these resins, and in addition to these, the polymer may also be produced by combining plural kinds of polymerizable monomers. Upon producing a resin by combining plural kinds of polymerizable monomers, for example, methods for forming copolymers, such as a block copolymer, a graft copolymer and a random copolymer, may be used, and in addition to these, there is also a resin forming method, such as a polymer blending method in which plural kinds of resins are mixed with one another.

The base particles that contain, for example, a styrene-acrylic-based resin, an acrylic-based resin or a fluorine-based resin among the above-mentioned resins tend to be charged with a negative polarity; therefore, the base particles are useful for negatively charged display particles. The base particles that contain, for example, a polyamide-based resin or a polymethacrylic resin tend to be charged with a positive polarity; therefore the base particles are useful for positively charged display particles.

The weight-average molecular weight of a resin constituting the base particles A is 5000 to 200000, particularly preferably 15000 to 100000 from the viewpoint of easily fixing the resin particles B.

In the present specification, the weight-average molecular weight is a value measured by a HLC-8220 (made by Tosoh Corporation).

Not particularly limited, pigments conventionally known in the field of the electrophotographic toner can be used as a colorant. Among these, examples of a white pigment constituting the white base particles include zinc oxide (zinc white), titanium oxide, antimony white, zinc sulfide, barium titanate, calcium titanate, strontium titanate or the like, and among these, titanium oxide is preferable. Examples of a black pigment constituting the black base particles include carbon black, copper oxide, manganese dioxide, aniline black, active carbon or the like, and among these, carbon black is preferable. Although not particularly limited, the content of the colorant may be, for example, 1 to 200 parts by weight relative to 100 parts by weight of the resin.

A charge controlling agent conventionally used in the field of the electrophotographic toner may be contained in the base particles A on demand.

Not particularly limited, charge controlling agents conventionally known in the field of the electrophotographic toner may be used as a charge controlling agent. Among these, base particles containing a negative-charge controlling agent, such as, for example, a salicylic acid metal complex, a metal-containing azo dye, a quaternary ammonium salt compound and a nitroimidazole derivative, are useful as negatively charged display particles. Base particles containing a positive-charge controlling agent, such as, for example, a nigrosine-based dye, a triphenylmethane compound and an imidazole derivative, are useful as positively charged display particles. Although not particularly limited, the content of the charge controlling agent may be, for example, 0.1 to 10 parts by weight relative to 100 parts by weight of the resin.

The volume-average particle size D1 of the base particles A is 1 to 50 μm, and preferably 1 to 30 μm. In the case where positively charged display particles and negatively charged display particles are used, supposing that the volume average particle size of the entire base particles of the base particles A1 for positively charged display particles and base particles A2 for negatively charged display particles is D1, and the value may be set within the above-mentioned range. When D1 is too small, the Van der Waals force increases to cause the display particles to mutually aggregate with one another, resulting in reduction in contrast. On the other hand, when D1 is too large, the stress upon driving increases because of the self-weight of the particles to cause embedded external additives, with the result that the repeatability deteriorates.

The volume-average particle size D1 of the base particles is indicated by a volume based median diameter (d50 diameter), and can be measured and calculated by using a device in which a data-processing computer system is connected to a Multisizer 3 (made by Beckman Coulter, Inc.).

The measurement procedures are described as follows: After a sample (0.02 g) has been properly mixed with a surfactant solution (20 ml) (used for dispersing particles; a surfactant solution prepared by diluting a neutral detergent containing a surfactant component by 10 times with pure water), this is dispersed by using ultrasonic waves for one minute so that a dispersion solution is prepared. This dispersion solution is injected into a beaker, inside a sample stand, which contains ISOTON II (made by Beckman Coulter, Inc.), by using a pipet, until a measured concentration of 10% is attained, and measurements are carried out with the measuring device counter being set to 2500. The multisizer 3 in which the aperture diameter is set to 5 μm is used.

The method for producing the base particles is not particularly limited, and conventionally known methods for producing particles containing a resin and a colorant, such as, for example, a method for producing toner to be used for forming images in an electrophotographic system, may be applied to be used. Specific methods for producing the base particles include, for example, the following methods.

(1) a method in which, after a resin and a colorant are mixed and kneaded with each other, the resulting kneaded matter is subjected to each of pulverizing and classifying processes so that base particles are produced;

(2) a so-called suspension polymerizing method in which, after a polymerizable monomer and a colorant are mechanically stirred in an aqueous medium to form droplets, a polymerizing process is carried out so that base particles are produced; and

(3) a so-called emulsion polymerizing aggregation method in which a polymerizable monomer is dropped into an aqueous medium containing a surfactant so that a polymerizing reaction is carried out in a micelle to produce polymer particles of 100 to 150 nm, and then colorant particles and a coagulant are added thereto so that these particles are aggregated and fused to produce base particles.

The resin fine particles B play following roles.

(1) The resin fine particles are mainly fixed on the surface of the base particle, resulting in that such a situation as if the irregularity is formed on the surface of the base particle is expressed. Thereby, resin fine particles function to form fine spaces between the base particle and the substrate (spacer effect).

The resin fine particles work to reduce an interaction caused by the contact of display particles with the substrate. In more particular, Van der Waals force and image force are deteriorated, resulting in reduction in the adhesive force between the display particles and the substrate, and improvement of contrast at lower driving voltage.

(2) The resin fine particles themselves are fixed to the base particles and work to fix inorganic fine particles to the base particles. In other words, the resin fine particles function as an adhesive to bond the inorganic fine particles to the base particles.

The resin fine particles B have an average primary particle size D2 of 30 to 250 nm, preferably 50 to 200 nm, and satisfy the following formula (1) in association with D1 of the base particles A. The value of D1/D2 is a value obtained by converting D1 and D2 to the same unit so as to be calculated.

10≦D1/D2≦1000, preferably 50≦D1/D2≦300 (1)

In the case where positively charged display particles and negatively charged display particles are used, supposing that the average primary particle size of the entire resin fine particles of the resin fine particles B1 contained in positively charged display particles and the resin fine particles B2 contained in negatively charged display particles is D2, the value may be set within the above-mentioned range, and allowed to satisfy the above-mentioned formula (1) in association with D1. When D2 is too small, the space effect provided by the resin fine particles B becomes smaller, failing to provide a sufficient contrast at low voltages. When D2 is too large, the resin fine particles B are hardly fixed onto the base particles, and allowed to be present in an isolated state, with the result that the effect is not obtained. In the case where D1/D2 is too small, since the base particles A are not uniformly coated with the resin particles B, the effect is not obtained. In the case where D1/D2 is too large, since the resin particles B are buried into the base particles A upon carrying out an externally adding process, with the result that the effect is not obtained. When referred to simply as “resin fine particles B”, it means the resin fine particles B1 and B2 inclusively.

The average primary particle size of the resin fine particles B is a number-average particle size of primary particles, and the number-based median diameter (d50 diameter) is obtained by using a value measured by a micro track UPA-150 (made by Nikkisou Co., Ltd.).

The measurements procedures are described as follows: To a measuring cylinder of 50 ml are put resin fine particles (0.1 g) to be measured, and to this is added 25 ml of pure water, and the resulting mixture is dispersed by using an ultrasonic washer “US-1 (AS ONE CORPORATION)” for 3 minutes so that a test sample is prepared. The test sample (3 ml) is then charged into a cell of a “micro track UPA-150” so that the value of “Sample Loading” is confirmed to be in the range between 0.1 to 100. Then, measurements are carried out under the following conditions.

### Measuring Conditions

Transparency: Yes

Refractive Index: 1.59

Particle Density: 1.05 g/cm³

Spherical Particles Yes

### Solvent Conditions

Refractive Index: 1.33

Viscosity: High (temp) 0.797×10-3 Pa·s

Low (temp) 1.002×10-3 Pa·s

The resin constituting the resin fine particles B is not particularly limited, and, for example, the resin exemplified as a resin for constituting the base particles A may be used.

The glass transition point (Tg) of the resin constituting the resin fine particles B is 40 to 200° C., and particularly preferably 50 to 100° C., from the viewpoint of fixing onto the base particles A.

In the present specification, Tg is obtained by using a value measured by a DSC-7 Differential Scanning Calorimeter (made by Parkin-Elmer Co., Ltd.).

The content of the resin fine particles B is 0.1 to 200 parts by weight, and particularly preferably 1 to 20 parts by weight, relative to 100 parts by weight of the base particles to which the resin fine particles are externally added, in order to reduce contact points between the display particles and the substrate and also to reduce the adhesive force exerted between the particles and the substrate. The resin fine particles B may be used in combination of two or more kinds, and in this case, the total amount of these may be within the above-mentioned range. In the case where positively charged display particles and negatively charged display particles are used, the contents of the resin fine particles B1/B2 are set so that respective values relative to 100 parts by weight of the base particles A1/A2 are preferably set within the above-mentioned range.

The inorganic fine particles C play following roles.

The inorganic fine particles are fixed mainly to the resin fine particles and function as contact points between the substrate and the display particles. In a manner similar to the resin fine particles, the inorganic fine particles effectuate to express such a situation as if the irregularity is formed on the surface of the resin fine particle. Thereby, inorganic fine particles function to form fine spaces between the display particles and the substrate (spacer effect). Similarly, Van der Waals force and image force are deteriorated. In a preferred embodiment, the surface of the inorganic fine particle is subjected to a hydrophobicizing treatment. Thereby, because the liquid cross-linking force, which is an interaction caused by absorbed water, is further reduced, the adhesive force between the display particles and the substrate are reduced, resulting in improvement of contrast at lower driving voltage.

The inorganic fine particles C have an average primary particle size D3 of 5 to 30 nm, preferably 5 to 20 nm, and satisfy the following formula (2) in association with D2 of the resin fine particles B. The value of D2/D3 is a value obtained by converting D2 and D3 to the same unit so as to be calculated.

2≦D2/D3≦50, preferably 5≦D2/D3≦20 (2)

In the case where positively charged display particles and negatively charged display particles are used, supposing that the average primary particle size of the entire inorganic fine particles of the inorganic fine particles C1 contained in the positively charged display particles and the inorganic fine particles C2 contained in negatively charged display particles is D3, the value may be set within the above-mentioned range, and allowed to satisfy the above-mentioned formula (2) in association with D2. When D3 is too small, the Van der Waals force between particles increases so that the particles are not broken upon carrying out the externally applying process, with the result that the inorganic fine particles C are present as aggregates, failing to provide the effect. When D3 is too large, the inorganic fine particles C are hardly fixed onto the resin fine particles B, and allowed to be present in an isolated state, with the result that the effect is not obtained. In the case where D2/D3 is too small, since the resin particles B are not uniformly coated with the inorganic fine particles C, the effect is not obtained. In the case where D2/D3 is too large, since the inorganic fine particles C are buried into the resin particles B upon carrying out an externally adding process, with the result that the effect is not obtained. When referred to simply as “inorganic fine particles C”, it means the inorganic fine particles C1 and C2 inclusively.

The average primary particle size of the inorganic fine particles C is a number-average particle size of primary particles (number-based median diameter (d50 diameter)), and calculated from an image photographed by a scanning type electron microscope.

The measurement procedures are described as follows: A photograph of particles, magnified by 100000 times, is photographed by a scanning-type electron microscope “JSM-7410” (made by JEOL LTD.), and with respect to each of the 200 particles, the largest length (the largest length between arbitrary two points on the circumference of each particle) is measured so that the number-average value thereof is defined as the average particle size. In the case where the particles are photographed as aggregates, the particle size of the primary particles forming each aggregate is supposed to be measured.

Although not particularly limited, examples of materials useable as the inorganic fine particles C include: metal oxides, such as silicon oxide, titanium oxide, aluminum oxide, tin oxide, zirconium oxide and tungsten oxide, nitrides such as titanium nitride, and titanium compounds, and silicon oxide is preferable because it provides a high degree of hydrophobicity.

From the viewpoint of reducing a liquid cross-linking force between the particles and the substrate, the inorganic fine particles C is preferably allowed to have a hydrophobic property. The hydrophobic property is imparted by treating the inorganic fine particles with a hydrophobicizing agent. Not particularly limited, examples of the hydrophobicizing agent also include any of silane coupling agents, such as chlorosilane, alkoxysilane, silazane, aminosilane and silylated isocyanate. Specific examples include: such as dimethyl dichlorosilane, trimethyl chlorosilance, methylmethoxy silane, isobutyltrimethoxy silane, hexamethyl disilazane, tert-butyldimethylchlorosilane, vinyltrichlorosilane, vinyltrimethoxysilane, vinyltriethoxysilane, isopropyl-tri(N-aminoethyl-aminoethyl) titanate, aminopropyltrimethoxy silane, aminopropyltriethoxy silane, dimethylaminopropyltrimethoxy silane, diethylaminopropyl trimethoxy silane, dipropylaminopropyltrimethoxy silane, dibutylaminopropyltrimethoxy silane, monobutylaminopropyltrimethoxy silane, dioctylaminopropyldimethoxy silane, dibutylaminopropyldimethoxy silane, dibutylaminopropylmonomethoxy silane, dimethylaminophenyl triethoxy silane, (N-(2-aminoethyl)-3-aminopropyltrimethoxy silane), (3-trimethoxysilylpropyl) diethylenetriamine, bis[3-(trimethoxysilyl)propyl] ethylenediamine, trimethoxysilyl-γ-propylphenylamine and trimethoxysilyl-γ-propylbenzylamine.

The inorganic fine particles C preferably exhibit a degree of hydrophobicity of 30 to 99.

The degree of hydrophobicity is obtained by using a value measured based upon methanol wettability. The methanol wettability is a factor used for evaluating the wettability to methanol. In this method, 0.2 g of inorganic fine particles to be measured are weighed and added to 50 ml of distilled water put in a beaker having an inner volume of 200 ml. Methanol is slowly dropped therein from a burette with its tip being immersed in the solution, while being slowly stirred, until the entire inorganic fine particles are moistened. Supposing that the amount of methanol required for completely moistening the inorganic fine particles is the value of “a” (ml), the degree of hydrophobicity is calculated from the following equation:

Degree of hydrophobicity={a/(a+50)}×100

From the viewpoint of providing flowability, the content of the inorganic fine particles C is 0.01 to 30 parts by weight, and particularly preferably 0.1 to 5 parts by weight relative to 100 parts by weight of the base particles to which the inorganic fine particles are externally added. Two or more kinds of the inorganic fine particles C may be used in combination, and in this case, the total amount of these may be set in the above-mentioned range. In the case where positively charged display particles and negatively charged display particles are used, the contents of the inorganic fine particles C1/C2 are set so that respective values relative to 100 parts by weight of the base particles A1/A2 are preferably set within the above-mentioned range.

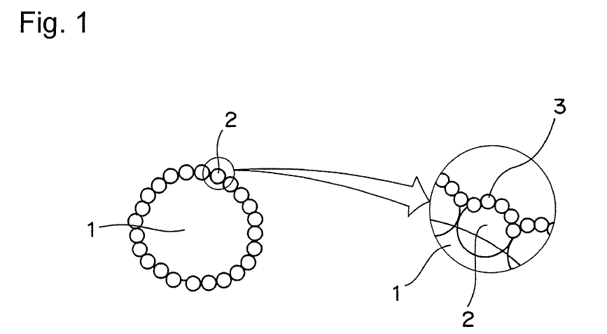

The display particles of the present invention can be produced by adding the resin fine particles B and the inorganic fine particles C to the base particles A to be mixed (production method 1), and preferably, they are produced by processes in which after the resin fine particles B are added to the base particles A to be mixed, the inorganic fine particles C are added to the mixture to be mixed (production method 2). In particular, in the case where display particles containing positively charged display particles and negatively charged display particles are used, the above-mentioned production method 1, preferably, production method 2, is adopted upon producing the respective display particles. In the production method, as wn in FIG. 1, a display particle having a two-stage lamination structure in which the surface of the base particle A(1) is coated with the resin fine particles B(2), with the surface of the resin fine particle B(2) being coated with the inorganic fine particles C(3), is obtained. The display particles having such a structure make it possible to reduce contact points between the particles and the substrate by coating the base particle A with the resin fine particles B, and furthermore to reduce a liquid cross-linking force between the particles and the substrate by coating the surface of the resin fine particle B with the inorganic fine particles C that is subjected to a hydrophobicizing treatment. As a result, since the adhesive strength of the display particles to the substrate is effectively reduced, images having comparatively high contrast can be displayed repeatedly even when the driving voltage is comparatively low.

In the above-mentioned two-stage lamination structure, the resin fine particles B are preferably fixed to the base particle A, and the inorganic fine particles C are preferably fixed to resin fine particles B. Thus, the above-mentioned effects can be obtained for a long period of time. For this reason, in the method for producing display particles, after the resin fine particles B are added to and mixed with the base particles A and inorganic fine particles C are added to and mixed with the mixture, the resulting mixture is preferably subjected to an instantaneous heating treatment. By using the instantaneous heating treatment, the fixing of the resin fine particles B to the base particles A and the fixing of the inorganic fine particles C to the resin fine particles B can be effectively carried out. The “fixing” is used as a concept including a phenomenon in which some portions of the resin fine particles B and the inorganic fine particles C are buried in the base particle A to be fixed thereto and a phenomenon in which some portions of the inorganic fine particles C are buried in the resin fine particles B to be fixed thereto, between different types of particles (between the base particles A and the resin fine particles B and the inorganic fine particles C, and between the resin fine particles B and the inorganic fine particles C).

The instantaneous heating treatment refers to a heating treatment in which hot air is instantaneously blown to a substance to be treated. The heating temperature may be such a temperature as to achieve the above fixation and not to cause complete burying of the particles and fusing between the same kind of particles, and determined depending on, for example, the weight-average molecular weight of the base particles A, Tg of the resin fine particles B and the like. Specifically, in the case where the weight-average molecular weight of the base particles A is about 5000 to 200000, with Tg of the resin fine particles B being about 40 to 200° C., the heating temperature is appropriately normally 80 to 300° C. As the device capable of carrying out such an instantaneous heating treatment, a commercially available hot-air spherizing device (Surfusing System SFS-3; made by Nippon Pneumatic MFG.) may be used.

The fixing rates of the resin fine particles B and the inorganic fine particles C in the display particles of the present invention are 50 to 99%, and particularly preferably 70 to 99%. In the case where positively charged display particles and negatively charged display particles are used, the above-mentioned fixing rate is preferably achieved in the entire display particles.

The above-mentioned fixing rate can be measured by determining the remaining rate of the resin fine particles B and the inorganic fine particles C when vibration is applied to the display particles. Specifically, a measuring method, which executes a first step for measuring the BET specific surface area (initial value) of the display particles, a second step for applying ultrasonic waves to the display particles in water and a third step for measuring the BET specific surface area (value after the process) of residues of the display particles from which free resin fine particles B and inorganic fine particles C are removed after the application of ultrasonic waves, may be adopted. With respect to the BET specific surface area, a proportion of value after the process relative to the initial value is calculated, and the resulting value (remaining rate) is defined as a fixing rate. The reason that the value is considered as the fixing rate is because, since the particle size of the base particle A is extremely large in comparison with those of the resin fine particles B and the inorganic fine particles C, the surface area of the base particle A is extremely small in comparison with those of the resin fine particles B and the inorganic fine particles C so that it is negligible.

Image Display Apparatus

The image display apparatus in accordance with the present invention is characterized by including the above-mentioned display particles. The image display apparatus of the present invention is explained in detail hereinafter. The image display apparatus according to the present invention is referred to also as “powder display”.

The image display apparatus according to the present invention has a structure in which the above-mentioned display particles in a powdered state are sealed between two substrates at least one of which is transparent, and by generating an electric field between the substrates, the display particles are moved so that an image is displayed.

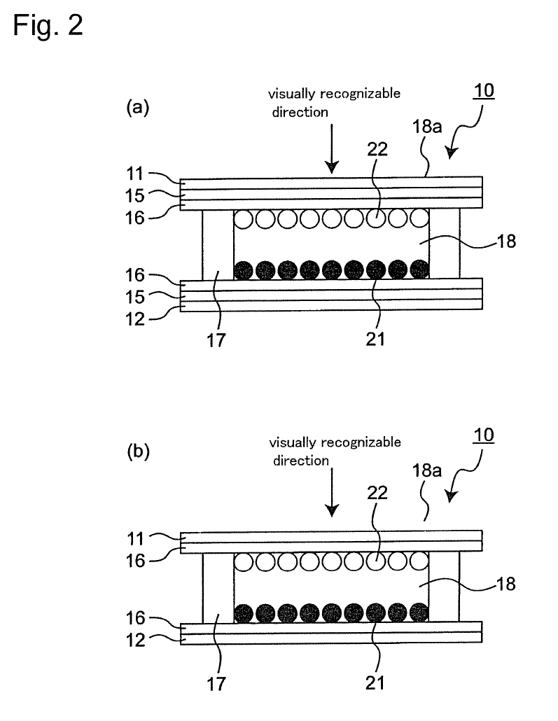

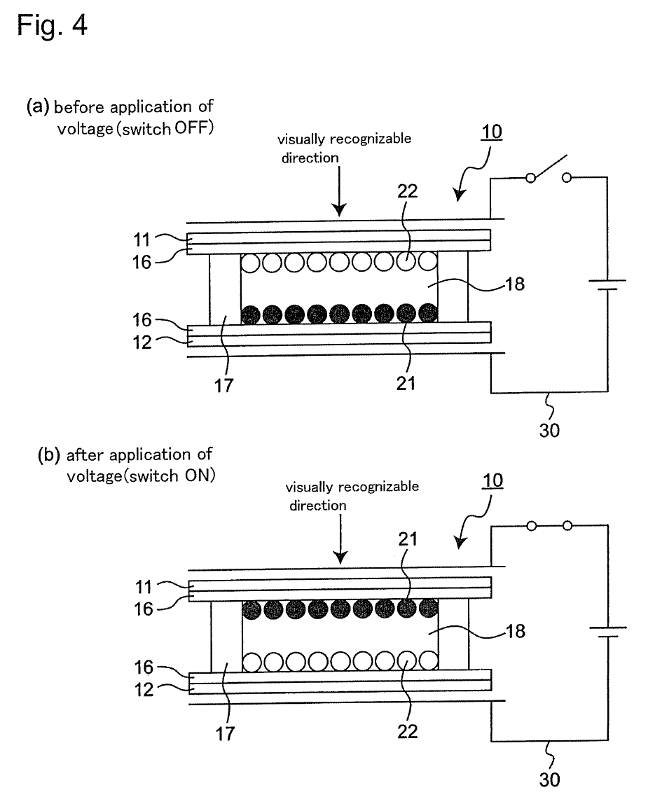

FIG. 2 shows a typical structural cross section of the image display apparatus in accordance with the present invention. FIG. 2(a) shows a structure in which electrodes 15 having a layer structure are provided on substrates 11 and 12, with an insulating layer 16 being provided on the surface of the electrodes 15. The image display apparatus of FIG. 2(b) has a structure in which no electrodes are provided inside the apparatus, and an electric field is applied thereto through electrodes provided on the outside of the apparatus so that the display particles can be moved. In FIGS. 2(a) and 2(b), the same members are indicated by the same reference numerals. FIG. 2 is supposed to indicate FIGS. 2(a) and 2(b) inclusively. As shown in the Figures, an image display apparatus 10 of FIG. 2 is supposed to allow images to be visually recognized from the substrate 11 side; however, the present invention is not intended to be limited by the structure in which images are visually recognized from the substrate 11 side. In the apparatus type shown in FIG. 2(b), since no electrodes 15 are provided in the apparatus itself, the structure of the apparatus can be simplified so that the advantage of shortening the manufacturing processes can be obtained. FIG. 4 shows a state in which the image display apparatus 10 of the type shown in FIG. 2(b) is set to a device capable of applying a voltage, with a voltage being applied thereto. The cross-sectional structure of the image display apparatus according to the present invention is not intended to be limited by those structures shown in FIGS. 2(a) and 2(b).

Two substrates 11 and 12 that are a case member constituting the image display apparatus are disposed face to face with each other on the outermost portion of the image display apparatus 10 of FIG. 2(a). On the surfaces on the side where the paired substrates 11 and 12 are made face to face with each other, electrodes 15 used for applying a voltage are provided, with insulating layers 16 being furthermore provided on the electrodes 15. The electrodes 15 and the insulating layers 16 are respectively provided on the substrate 11 and the substrate 12, and display particles are located in a gap 18 formed by making the surfaces on the side having the electrodes 15 and the insulating layers 16 face to face with each other. In the image display apparatus 10 shown in FIG. 2, two kinds of display particles, that is, black display particles (hereinafter, referred to as black particles) 21 and while display particles (hereinafter, referred to as white particles) 22 are placed in the gap 18 as the display particles. The aforementioned resin fine particles and inorganic fine particles are externally added to and present on the surface of each black particle 21 and each white particle 22; however, these are not shown. In the image display apparatus 10 of FIG. 2, the gap 18 is surrounded from four sides by the substrates 11 and 12 and two partition walls 17, and the display particles are located in the gap 18 in a sealed state.

The thickness of the gap 18 is not particularly limited as long as it allows the sealed display particles to move and can maintain the contrast of an image, and is normally 10 μm to 500 μm, preferably 1 μm to 100 μm. The volume occupation rate of the display particles inside the gap 18 is 5% to 70%, preferably 30% to 60%. By setting the volume occupation rate of the display particles in the above-mentioned range, the display particles are allowed to move smoothly in the gap 18, and further, an image with superior contrast can be obtained.

The behaviors of the display particles in the gap 18 of the image display apparatus 10 is explained hereinafter.

In the image display apparatus in accordance with the present invention, when a voltage is applied between the two substrates to form an electric field, the charged display particles are allowed to move along the electric field direction. In this manner, by applying a voltage between the substrates where the display particles are present, the charged display particles move between the substrates so that an image is displayed.

The image displaying operations in the image display apparatus of the present invention is carried out as the following procedures:

(1) The display particles used as display media are charged by using a known method, such as frictional charging by the use of carriers.

(2) The display particles are sealed between the two opposing substrates, and in this state, a voltage is applied between the substrates.

(3) By the application of a voltage between the substrates, an electric field is formed between the substrates.

(4) The display particles are attracted toward the substrate surface along the electric field direction opposite to the polarity of the display particles due to a function of the force of the electric field between the electrodes to carry out image displaying.

(5) The moving directions of the display particles are switched by changing the electric-field direction between the substrates. The image display can be changed variously by switching the moving directions.

Examples of the charging method for display particles by the above-mentioned conventional method include such as a method for charging the display particles through frictional charging by allowing them to contact with carriers and a method for mixing and stirring display particles with two colors having different charging polarities so that the display particles are charged through frictional charging between the two particles, and in the present invention, a method in which the carriers are used for charging the display particles, and the charged display particles are sealed between the substrates is preferably used.

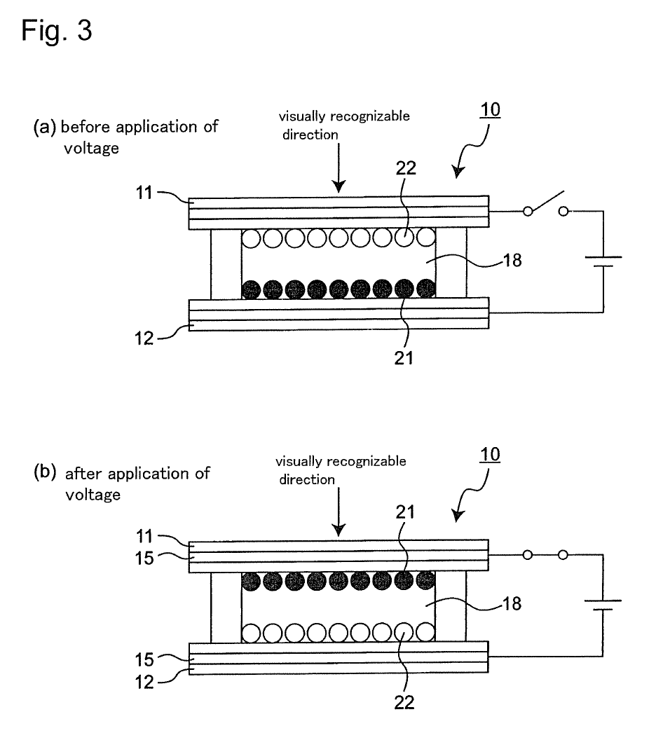

FIGS. 3 and 4 show examples of the movements of the display particles with an application of a voltage between the substrates.

FIG. 3(a) shows a state prior to the application of the voltage between the substrates 11 and 12, and prior to the application of the voltage, the white particles 22 positively charged are present near the substrate 11 on the image-visible side. In this state, a white image is displayed on the image display apparatus 10. FIG. 3(b) shows a state after the application of the voltage to the electrodes 15 in which negatively charged black particles 21 due to the application of a positive voltage to the substrate 11 are allowed to move close to the substrate 11 on the image-visible side, with the white particles 22 moving toward the substrate 12 side. In this state, a black image is displayed on the image display apparatus 10.

FIG. 4 shows a state in which an image display apparatus 10 of the type having no electrodes, shown in FIG. 2(b), is set to a voltage application device 30, and in this state, a state prior to an application of a voltage (FIG. 4(a)) and a state after the application of the voltage (FIG. 4(b)) are shown. In the same manner as in the image display apparatus 10 having the electrodes 15, the image display apparatus 10 of the type shown in FIG. 2(b) also has a structure in which by applying a positive voltage to the substrate 11, the negatively charged black particles 21 are allowed to move close to the substrate 11 on the image-visible side, with the white particles 22 moving toward the substrate 12 side.

The following description is about the substrates 11 and 12, electrodes 15, insulating layer 16 and partition walls 17 that constitute the image display apparatus 10 shown in FIG. 2.

First, the substrates 11 and 12 constituting the image display apparatus 10 are explained. In the image display apparatus 10, since a viewer visually recognizes an image formed by the display particles from at least one of the sides of the substrates 11 and 12, the substrate on the side through which the viewer recognizes the image needs to be made from a transparent material. Therefore, the substrate to be used for the side through which the viewer recognizes the image is preferably made from a light-transmitting material having, for example, a visible light transmittance of 80% or more, and by providing the visible light transmittance of 80% or more, it is possible to obtain sufficient visibility. Of the substrates forming the image display apparatus 10, the substrate placed on the side opposite to the image-recognizing side does not need to be made from a transparent material.

The thicknesses of the substrates 11 and 12 are preferably 2 μm to 5 mm respectively, more preferably Sum to 2 mm. When the thicknesses of the substrates 11 and 12 are within the above-mentioned range, it is possible to provide a sufficient strength for the image display apparatus 10, and also to maintain the distance between the substrates uniformly. By setting the thicknesses of the substrates within the above-mentioned range, it becomes possible to provide a compact and light-weight image display apparatus, and consequently to accelerate use of the image display apparatus in wider fields. Furthermore, by setting the thickness of the substrate on the image-recognizing side within the above-mentioned range, the displayed image can be visually recognized accurately, without causing any problems in display quality.

Example of the material having a visible light transmittance of 80% or more include inorganic materials having no flexibility, such as glass and quartz, organic materials, typically represented by resin materials to be described later, metal sheets, or the like. Among these, the organic materials and metal sheets may provide a certain degree of flexibility for the image display apparatus. Examples of the resin materials capable of providing a visible light transmittance of 80% or more include polyester resins typically represented by such as polyethylene terephthalate and polyethylene naphthalate, polycarbonate resins, polyether sulfone resins, polyimide resins and the like. Acrylic resins that are polymers of acrylates and methacrylates, typically represented by polymethyl methacrylate (PMMA), and transparent resins obtained by radical-polymerizing a vinyl-based polymerizable monomer, such as a polyethylene resin, may also be included.

The electrodes 15 are provided on the surfaces of the substrates 11 and 12, and used for forming an electric field between the substrates, that is, in a gap 18, by application of a voltage. In the same manner as in the aforementioned substrate, the electrodes 15 that are transparent need to be provided on the image-visible side by the viewer.

The thickness of the electrodes provided on the image-visible side needs to be such a level as to ensure conductivity and as not to cause problems with the light transmitting property, and specifically, it is preferably 3 nm to 1 μm, more preferably 5 nm to 400 nm. The visible light transmittance of the electrodes to be provided on the image-visible side is preferably set to 80% or more in the same manner as in the substrate. The thickness of the electrode to be provided on the side opposite to the image-visible side is also preferably within the above-mentioned range; however, the electrode is not necessarily required to be transparent.

Examples of the constituent material for the electrodes 15 include metal materials, conductive metal oxides, or conductive polymer materials etc. Specific examples of the metal materials include aluminum, silver, nickel, copper and gold, and specific examples of the conductive metal oxides include indium-tin oxides (ITO), indium oxides, antimony-tin oxides (ATO), tin oxides, zinc oxides and the like. Examples of the conductive polymer materials include polyaniline, polypyrrole, polythiophene, polyacetylene and the like.

Examples of the method for forming the electrodes 15 on the substrates 11 and 12 include a sputtering method, a vacuum vapor deposition method, a chemical vapor deposition method (CVD method), a coating method and the like upon providing film-shaped electrodes. A method in which a conductive material is mixed with a solvent or a binder resin and the resulting mixture is applied onto the substrate to form electrodes may also be used.

The insulating layer 16 is designed to be provided on the surface of the electrodes 15, with the display particles 21 and 22 being made in contact with the surface of the insulating layer 16; however, it is not necessarily required to be provided. The insulating layer 16 has a function for alleviating a change in the quantity of charge by a voltage to be applied upon moving the display particles 21 and 22. By using a resin having highly hydrophobic property, or by providing irregularities thereon, its physical adhesive strength to the display particles can be reduced so that it is also allowed to have a function for reducing the driving voltage. Examples of the material for forming the insulating layer 16 are those materials that have an electrical insulating property, can be formed into a thin film, and are also transparent, if necessary. The insulating layer to be provided on the image-visible side is preferably made to have a visible-light transmittance of 80% or more, in the same manner as in the substrate. Specific examples thereof include silicone resins, acrylic resins polycarbonate resins and the like.

The thickness of the insulating layer 16 is preferably 0.01 μm or more to 10.0 μm or less. That is, when the thickness of the insulating layer 16 is in the above-mentioned range, the display particles 21 and 22 can be moved without the necessity of applying a high voltage between the electrodes 15, and this thickness is preferable because, for example, an image-displaying operation can be carried out by using a voltage in the same level applied upon forming an image by using an electrophoretic method.

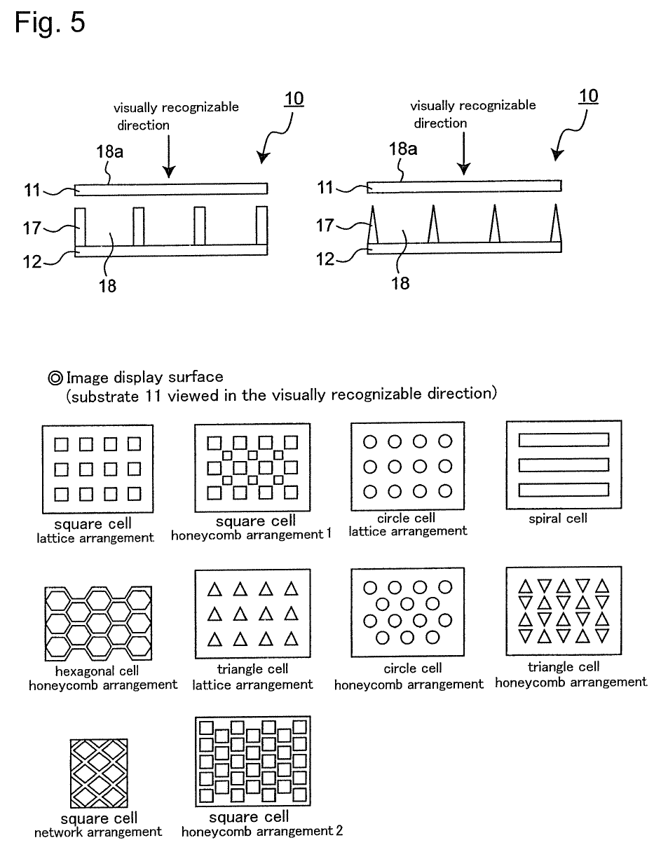

The partition walls 17, which ensure the gap 18 between the upper and lower substrates, may be formed not only on the edge portions of the substrates 11 and 12 as shown on the right side and left side of the upper stage of FIG. 5, but also inside thereof, if necessary. The width of the partition walls 17, in particular, the thickness of the partition wall on the image display face 18a side, is desirably made as thin as possible from the viewpoint of ensuring the clearness of a display image, for example, as shown on the right side of the upper stage of FIG. 5.

The partition walls 17 to be formed inside the substrates 11 and 12 may be formed continuously, or may be formed intermittently, in the surface and rear surface direction in the Figure on the right side as well as on the left side on the upper stage of FIG. 5.

By controlling the shape and the arrangement of the partition walls 17, cells to be placed between the gap 18 and separated by the partition walls 17 can be disposed with various shapes. Examples of the shapes and arrangement of the cells, obtained when the gap 18 is viewed in the visually recognizable direction of the substrate 11, are shown in a lower-stage drawing of FIG. 5. As shown in the lower-stage drawing of FIG. 5, a plurality of cells may be arranged in a honeycomb pattern or a net-work pattern, with a shape, such as a square shape, a triangular shape, a line shape, a round shape and a hexagonal shape.

The partition walls 17 can be formed by processing the surface of the substrate on the side opposite to the image-visible side by using, for example, the following methods. Examples of the methods for forming the partition walls 17 include such as a concave/convex pattern forming process by using an emboss processing and a thermal press-injection molding with a resin material or the like, as well as a photolithographic method and a screen printing method.

### EXAMPLES

### Example 1

### Production of White Display Particles

(White Base Particles)

The following resin and titanium oxide were charged into a Henschel mixer (made by Mitsui Miike Mining Co., Ltd.), and mixed for 5 minutes, with a peripheral velocity of stirring blades being set to 25 m/sec. so that a mixture was produced.

Styrene acrylic resin (weight-average molecular weight 20,000): 100 parts by weight Anatase-type titanium oxide (average primary particle size 150 nm): 30 parts by weight

The above-mentioned mixture was kneaded by using a twin-screw extrusion kneader, then coarsely pulverized by a hammer mill, and subjected to a grinding process by using a Turbomill grinder (made by Turbo Kogyo Co., Ltd.) and furthermore subjected to a fine powder classifying process by using an air-flow classifier that utilizes the Coanda effect so that white base particles, having a volume-average particle size of 10.0 μm, were produced.

(Resin Fine Particles)

To 100 parts by weight of the above white base particles was added 6.6 parts by weight of polyacrylic resin particles (average primary particle size: 100 nm, Tg: 60° C.), and this was charged into a Henschel mixer (made by Mitsui Miike Mining Co., Ltd.), and mixed for 30 minutes, with a peripheral velocity of stirring blades being set to 55 m/sec.

(Inorganic Fine Particles)

To this were successively added 0.9 parts by weight of silica particles having an average primary particle size of 15 nm that was treated by an amino silane coupling agent (aminopropyltrimethoxy silane), and this was mixed for 5 minutes by using a Hybridizer (made by Nara Machinery Co., Ltd.), with its number of revolutions being set to 10,000 rpm, so that white display particles were produced.

Thereafter, the resulting display particles were subjected to an instantaneous heating treatment by using a hot-air spherizing device (Surfusing System SFS-3; made by Nippon Pneumatic MFG.) under conditions of an inlet hot-air temperature of 100° C., a hot-air flow rate of 1.0 m³ and a material charging rate of 1.0 kg/h, with its hot-air treatment time being 0.03 sec.

Production of Black Display Particles

(Black Base Particles)

The following resin and carbon black were charged into a Henschel mixer (made by Mitsui Miike Mining Co., Ltd.), and mixed for 5 minutes, with a peripheral velocity of stirring blades being set to 25 m/sec. so that a mixture was produced.

Styrene acrylic resin (weight-average molecular weight 20,000):

100 parts by weight

Carbon black (average primary particle size 25 nm): 10 parts by weight

The above-mentioned mixture was kneaded by using a twin-screw extrusion kneader, then coarsely pulverized by a hammer mill, and then subjected to a coarse grinding process by using a Turbomill grinder (made by Turbo Kogyo Co., Ltd.) and furthermore subjected to a fine powder classifying process by using an air-flow classifier that utilizes the Coanda effect so that black base particles, having a volume-average particle size of 10.0 μm, were produced.

(Resin Fine Particles)

To 100 parts by weight of the above black base particles was added 6.6 parts by weight of polyfluoroacrylic resin particles (average primary particle size: 100 nm, Tg: 68° C.), and this was charged into a Henschel mixer (made by Mitsui Miike Mining Co., Ltd.), and mixed for 30 minutes, with a peripheral velocity of stirring blades being set to 55 m/sec.

(Inorganic Fine Particles)

To this were successively added 0.9 parts by weight of silica particles having an average primary particle size of 15 nm that was subjected to a dimethyldichloro silane treatment, and this was mixed for 5 minutes by using a Hybridizer (made by Nara Machinery Co., Ltd.), with its number of revolutions being set to 10,000 rpm, so that black display particles were produced.

Thereafter, the resulting display particles were subjected to an instantaneous heating treatment by using a hot-air spherizing device (Surfusing System SFS-3; made by Nippon Pneumatic MFG.) under conditions of an inlet hot-air temperature of 100° C., a hot-air flow rate of 1.0 m³ and a material charging rate of 1.0 kg/h, with its hot-air treatment time being 0.03 sec.

Carrier a Used for Charging White Display Particles

To 100 parts by weight of ferrite cores having an average particle size of 80 μm were added 2 parts of fluorinated acrylate resin particles, and these materials were charged into a horizontal rotation blade-type mixing machine, and mixed and stirred for 10 minutes at 22° C., with a peripheral speed of the horizontal rotation blades being set to 8 m/sec., and this was then heated at 90° C., and stirred for 40 minutes so that carrier A was produced.

Carrier B Used for Charging Black Display Particles

To 100 parts by weight of ferrite cores having an average particle size of 80 μm were added 2 parts of cyclohexyl methacrylate resin particles, and these materials were charged into a horizontal rotation blade-type mixing machine, and mixed and stirred for 10 minutes at 22° C., with a peripheral speed of the horizontal rotation blades being set to 8 m/sec., and this was then heated at 90° C., and stirred for 40 minutes so that carrier B was produced.

Production of Image Display Apparatus

An image display apparatus was manufactured by using the following method so as to have the same structure as shown in FIG. 2(a). Two glass substrates 11, each having a length of 80 mm, a width of 50 mm and a thickness of 0.7 mm, were prepared, and the electrode 15 made of a coat film (resistance 30Ω/□) of indium-tin oxide (ITO) having a thickness of 300 nm were formed on each of the substrates by a vapor deposition method. On the above electrodes, a coating solution, prepared by dissolving 12 g of polycarbonate resin in a mixed solvent of 80 ml of tetrahydrofuran and 20 ml of cyclohexane, was applied by using a spin coating method so that an insulating layer 16 having a thickness of 3 μm was formed; thus, a pair of substrates with electrodes formed thereon were obtained.

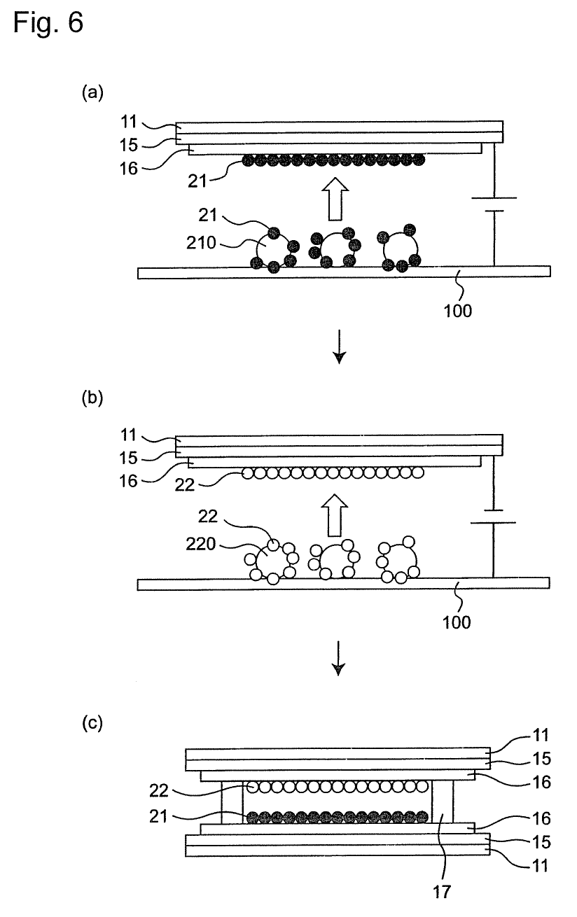

Black display particles (1 g) and carrier B (9 g) were mixed for 30 minutes by using a shaker (YS-LD, made by Yayoi Co., Ltd.) so that the display particles were charged. The resulting mixture (21, 210) was placed on a conductive stage 100 as shown in FIG. 6(a), and one of the substrates with electrodes formed thereto was placed with a gap of about 2 mm interposed to the stage 100. A DC bias of +50 V and an AC bias of 2.0 kV having a frequency of 2.0 kHz were applied between the electrode 15 and the stage 100 for 10 seconds so that the black display particles 21 were adhered onto the insulating layer 16.

White display particles (1 g) and carrier A (9 g) were mixed for 30 minutes by using a shaker (YS-LD, made by Yayoi Co., Ltd.) so that the display particles were charged. The resulting mixture (22, 220) was placed on a conductive stage 100 as shown in FIG. 6(b), and the other substrate with electrodes formed thereto was placed with a gap of about 2 mm interposed to the stage 100. A DC bias of −50 V and an AC bias of 2.0 kV having a frequency of 2.0 kHz were applied between the electrode 15 and the stage 100 for 10 seconds so that the white display particles 22 were adhered onto the insulating layer 16.

The substrate with the electrode to which the black display particles adhered and the substrate with electrode to which the white display particles adhered were superposed as shown in FIG. 6(c) with a gap being adjusted to 50 μm by partition walls, and peripheral portions of the substrates were bonded to each other with an epoxy adhesive so that an image display apparatus was formed. The volume occupation rate of the two kinds of display particles between the glass substrates was 50%. The occupation rate between the white display particles and the black display particles was set to virtually 1/1 in the number ratio of the white display particles/the black display particles.

### Examples 2 to 7, Comparative Examples 1 to 6

### Production of White Display Particles and Black Display Particles

White display particles and black display particles were produced by using the same method as that of example 1, except that white base particles and black base particles, produced by carrying out a classifying process so that their volume-average particle sizes became predetermined values, were used and that predetermined amounts of predetermined resin fine particles and inorganic fine particles were used.

### Example 8

White display particles and black display particles were produced by using the same method as that of example 1 except that the instantaneous heating treatment was not carried out.

Production of Image Display Apparatus

An image display apparatus was manufactured by using the same method as that of example 1 except that the white display particles and black display particles obtained as described above were used.

Evaluation

A DC voltage was applied to the image display apparatus according to the following procedures, and the reflection density of a displayed image obtained by the voltage application was measured so that display characteristics were evaluated. The voltage application was carried out through the following procedures in which the voltage is applied in a manner so as to follow a hysteresis curve having a route in which, after the applied voltage is changed from 0V to the plus side, it is successively changed to the minus side, and then again returned to 0V. That is:

(1) A voltage application is carried out while the voltage is being varied from 0V to +100V with intervals of 20V.

(2) A voltage application is carried out while the voltage is being varied from +100V to −100V with intervals of 20V.

(3) A voltage application is carried out while the voltage is being varied from −100V to 0V with intervals of 20V.

In the case where the DC voltage was applied to each of the image display apparatuses by using the above-mentioned procedures, it was confirmed that, upon application of a plus voltage in a white display state, the display was changed from white to black. The voltage to be applied to the electrode on the upstream side in the visually recognizing direction of the image display apparatus was changed, with the electrodes on the other side being grounded. The density was measured with a reflection densitometer “RD-918 (made by Macbeth Process Measurements Co.)”.

The contrast was evaluated as one of display characteristics, and the repeatability was furthermore evaluated.

(Contrast)

The contrast was evaluated based upon a density difference defined by a difference between the black density and the white density, that is:

Contrast=Black Density−White Density

The black density corresponds to a reflection density of the display surface obtained upon application of a voltage of +100V to the electrode on the upstream side in the visually recognizable direction of the image display apparatus.

The white density corresponds to a reflection density of the display surface obtained upon application of a voltage of −100V to the electrode on the upstream side in the visually recognizable direction of the image display apparatus.

The density was measured with a reflection densitometer “RD-918 (made by Macbeth Process Measurements Co.)” at each of five positions randomly selected on the display surface, and the average value was used.

The contrast was ranked under a three-grade criterion, that is, superior (◯) when the density difference is 1.00 or more, permissible (Δ) when the density difference is 0.70 or more, and impermissible (x) when the density difference is less than 0.70.

(Repeatability)

The repeatability was measured by alternately repeating voltage applications of +100V and −100V, and the reflection density was measured each time, and when the contrast became 0.50, the evaluation was made based upon the number of repetitions at this time. When the number of repetitions was 5000 times or more, it was evaluated as “superior (◯)”, when the number of repetitions was 1000 times or more, it was evaluated as “permissible (Δ), and when the number of repetitions was less than 1000 times, it was evaluated as “impermissible (x).”

(Minimum Driving Voltage)

When an application voltage was varied from 0V to 200V with intervals of 5V, the voltage, obtained at the time when the value of the display density became 0.7 or more, was defined as the maximum driving voltage. When the minimum voltage was 80V or less, it was evaluated as “superior (◯)”, when the minimum voltage was 100V or less, it was evaluated as “permissible (Δ), and when the minimum voltage was more than 100V, it state was evaluated as “impermissible (x).”

(Fixing Rate)

The fixing rate was measured on display particles composed of white display particles and black display particles having the same amount that were mixed with each other, by using the following method. First, the BET specific surface area of the display particles (BET specific surface area A) was measured by using a Micromeritics JEMINI 2360 (made by Shimadzu Corporation). Display particles (4 g) were dispersed in 40 g of a 0.2% aqueous solution of polyoxyethylphenyl ether, and moistened, and to this was then applied ultrasonic wave energy for 5 minutes by a ultrasonic wave type Homogenizer US-1200T (made by Nippon Seiki Co., Ltd.; specification frequency: kHz), with the value of an ampere meter showing an indicator value, attached to the main device, being adjusted to 60 μA (50 w). The resulting mixed solution was suction-filtrated, and only the solid component on a filter paper was sufficiently dried so that the BET specific surface property of this sample was measured (BET specific surface area B). The fixing rate was obtained from the following equation:

Fixing Rate (%)=(BET specific surface area B)/(BET specific surface area A)×100

TABLE 1

| | | | Example 1 | Example 2 | Example 3 | Example 4 |
|---|---|---|---|---|---|---|
| White | Base | D1 (nm) | 10000 | 1000 | 50000 | 40000 |
| display | particles | | | | | |
| particles | A1 | | | | | |
| | Resin | Kind: D2 (nm) | Polyacrylic | Polyacrylic | Polyacrylic | Polyacrylic |
| | fine | | resin 100 | resin 30 | resin 250 | resin 40 |
| | particles | Amount | 6.6 | 0.1 | 200 | 1.5 |
| | B1 | of addition | | | | |
| | | (parts) | | | | |
| | Inorganic | Kind: D3 (nm) | Silica treated by | Silica treated by | Silica treated by | Silica treated by |
| | fine | | amino silane | amino silane | amino silane | amino silane |
| | particles | | coupling agent 15 | coupling agent 5 | coupling agent 30 | coupling agent 5 |
| | C1 | Amount | 0.9 | 0.01 | 30 | 0.9 |
| | | of addition | | | | |
| | | (parts) | | | | |
| | | Degree of | 78 | 82 | 77 | 82 |
| | | hydrophobicity | | | | |
| | | (%) | | | | |
| | D1/D2 | | 100 | 33 | 200 | 1000 |
| | D2 /D3 | | 6.7 | 6.0 | 8.3 | 8.0 |
| Black | Base | D1 (nm) | 10000 | 1000 | 50000 | 40000 |
| display | particles | | | | | |
| particles | A2 | | | | | |
| | Resin | Kind: D2 | Polyfluoroacrylate | Polyfluoroacrylate | Polyfluoroacrylate | Polyfluoroacrylate |
| | fine | (nm) | 100 | 30 | 250 | 40 |
| | particles | Amount | 6.6 | 6.6 | 200 | 1.5 |
| | B2 | of addition | | | | |
| | | (parts) | | | | |
| | Inorganic | Kind: D3 | Silica treated by | Silica treated by | Silica treated by | Silica treated by |
| | fine | (nm) | dimethyldichloro | dimethyldichloro | dimethyldichloro | dimethyldichloro |
| | particles | | silane 15 | silane 5 | silane 30 | silane 15 |
| | C2 | Amount | 0.9 | 0.01 | 30 | 0.9 |
| | | of addition | | | | |
| | | (parts) | | | | |
| | | Degree of | 92 | 95 | 89 | 92 |
| | | hydrophobicity | | | | |
| | | (%) | | | | |
| | D1/D2 | | 100 | 33 | 200 | 1000 |
| | D2/D3 | | 6.7 | 6.0 | 8.3 | 2.7 |
| Evaluation | Contrast | | ◯ (1.4) | Δ (0.95) | Δ (0.88) | Δ (0.72) |
| | Minimum driving | | ◯ (75 V) | Δ (95 V) | Δ (85 V) | Δ (85 V) |
| | voltage | | | | | |
| | Repeatability | | ◯ | ◯ | ◯ | Δ |
| | Fixing rate (%) | | 95 | 85 | 82 | 72 |
| | | | Example 5 | Example 6 | Example 7 | Example 8 |
| White | Base | D1 (nm) | 40000 | 2500 | 10000 | 10000 |
| display | particles | | | | | |
| particles | A1 | | | | | |
| | Resin | Kind: D2 (nm) | Polyacrylic | Polyacrylic | Polyacrylic | Polyacrylic |
| | fine | | resin 250 | resin 250 | resin 30 | resin 100 |
| | particles | Amount | 150 | 200 | 2.5 | 6.6 |
| | B1 | of addition | | | | |
| | | (parts) | | | | |
| | Inorganic | Kind: D3 (nm) | Silica treated by | Silica treated by | Silica treated by | Silica treated by |
| | fine | | amino silane | amino silane | amino silane | amino silane |
| | particles | | coupling agent 5 | coupling agent 5 | coupling agent 15 | coupling agent 15 |
| | C1 | Amount | 0.05 | 0.05 | 0.1 | 0.9 |
| | | of addition | | | | |
| | | (parts) | | | | |
| | | Degree of | 82 | 82 | 78 | 78 |
| | | hydrophobicity | | | | |
| | | (%) | | | | |
| | D1/D2 | | 160 | 10 | 333 | 100 |
| | D2 /D3 | | 50.0 | 50.0 | 2.0 | 6.7 |
| Black | Base | D1 (nm) | 40000 | 2500 | 10000 | 10000 |
| display | particles | | | | | |
| particles | A2 | | | | | |
| | Resin | Kind: D2 | Polyfluoroacrylate | Polyfluoroacrylate | Polyfluoroacrylate | Polyfluoroacrylate |
| | fine | (nm) | 250 | 250 | 30 | 100 |
| | particles | Amount | 150 | 150 | 2.5 | 6.6 |
| | B2 | of addition | | | | |
| | | (parts) | | | | |
| | Inorganic | Kind: D3 | Silica treated by | Silica treated by | Silica treated by | Silica treated by |
| | fine | (nm) | dimethyldichloro | dimethyldichloro | dimethyldichloro | dimethyldichloro |
| | particles | | silane 5 | silane 5 | silane 15 | silane 15 |
| | C2 | Amount | 0.05 | 0.05 | 0.1 | 0.9 |
| | | of addition | | | | |
| | | (parts) | | | | |
| | | Degree of | 95 | 95 | 92 | 92 |
| | | hydrophobicity | | | | |
| | | (%) | | | | |

| | | | | | |
|---|---|---|---|---|---|
| | D1/D2 | 160 | 10 | 333 | 100 |
| | D2/D3 | 50.0 | 50.0 | 2.0 | 6.7 |
| Evaluation | Contrast | Δ (0.98) | Δ (0.70) | Δ (0.81) | Δ (0.95) |
| | Minimum driving | Δ (95 V) | Δ (100 V) | Δ (90 V) | Δ (85 V) |
| | voltage | | | | |
| | Repeatability | ◯ | Δ | Δ | Δ |
| | Fixing rate (%) | 88 | 70 | 75 | 52 |

TABLE 2

| | | | Comparative | Comparative | Comparative |
|---|---|---|---|---|---|
| | | | Example 1 | Example 2 | Example 3 |
| White | Base particles | D1 | 900 | 55000 | 40000 |
| display | A1 | (nm) | | | |
| particles | Resin fine | Kind: D2 | Polyacrylic | Polyacrylic | Polyacrylic |
| | particles | (nm) | resin 25 | resin 270 | resin 30 |
| | B1 | Amount of | 0.09 | 220 | 1.5 |
| | | addition (parts) | | | |
| | Inorganic | Kind: D3 | Silica treated by | Silica treated by | Silica treated by |
| | fine | (nm) | amino silane | amino silane | amino silane |
| | particles | | coupling | coupling | coupling |
| | C1 | | agent 4 | agent 40 | agent 5 |
| | | Amount of | 0.009 | 40 | 0.9 |
| | | addition (parts) | | | |
| | | Degree of | 80 | 75 | 82 |
| | | hydrophobicity (%) | | | |
| | D1/D2 | | 36 | 204 | 1333 |
| | D2/D3 | | 6.3 | 6.8 | 6.0 |
| Black | Base particles | D1 | 900 | 55000 | 40000 |
| display | A2 | (nm) | | | |
| particles | Resin fine | Kind: D2 | Polyfluoroacryl | Polyfluoroacryl | Polyfluoroacryl |
| | particles | (nm) | 25 | 970 | 30 |
| | B2 | Amount of | 0.09 | 220 | 1.5 |
| | | addition (parts) | | | |
| | Inorganic | Kind: D3 | Silica treated by | Silica treated by | Silica treated by |
| | fine | (nm) | dimethyldichloro | dimethyldichloro | dimethyldichloro |
| | particles | | silane 4 | silane 40 | silane 15 |
| | C2 | Amount of | 0.009 | 40 | 0.9 |
| | | addition (parts) | | | |
| | | Degree of | 94 | 86 | 92 |
| | | hydrophobicity (%) | | | |
| | D1/D2 | | 36 | 204 | 1333 |
| | D2/D3 | | 6.3 | 6.8 | 2.0 |
| Evaluation | Contrast | | X(0.62) | X(0.68) | X(0.52) |
| | Minimum driving voltage | | X(150 V) | X(110 V) | X(150 V) |
| | Repeatability | | X | X | Δ |
| | Fixing rate (%) | | 95 | 48 | 70 |
| | | | Comparative | Comparative | Comparative |
| | | | Example 4 | Example 5 | Example 6 |
| White | Base particles | D1 | 40000 | 2000 | 10000 |
| display | A1 | (nm) | | | |
| particles | Resin fine | Kind: D2 | Polyacrylic | Polyacrylic | Polyacrylic |
| | particles | (nm) | resin 270 | resin 250 | resin 30 |
| | B1 | Amount of | 150 | 200 | 2.5 |
| | | addition (parts) | | | |
| | Inorganic | Kind: D3 | Silica treated by | Silica treated by | Silica treated by |
| | fine | (nm) | amino silane | amino silane | amino silane |
| | particles | | coupling | coupling | coupling |
| | C1 | | agent 5 | agent 5 | agent 20 |
| | | Amount of | 0.05 | 0.05 | 0.1 |
| | | addition (parts) | | | |
| | | Degree of | 82 | 82 | 78 |
| | | hydrophobicity (%) | | | |
| | D1/D2 | | 148 | 8 | 333 |
| | D2/D3 | | 54.0 | 50.0 | 1.5 |
| Black | Base particles | D1 | 40000 | 2000 | 10000 |
| display | A2 | (nm) | | | |
| particles | Resin fine | Kind: D2 | Polyfluoroacryl | Polyfluoroacryl | Polyfluoroacryl |
| | particles | (nm) | 260 | 250 | 30 |
| | B2 | Amount of | 150 | 150 | 2.5 |
| | | addition (parts) | | | |
| | Inorganic | Kind: D3 | Silica treated by | Silica treated by | Silica treated by |
| | fine | (nm) | dimethyldichloro | dimethyldichloro | dimethyldichloro |
| | particles | | silane 5 | silane 5 | silane 20 |
| | C2 | Amount of | 0.05 | 0.05 | 0.1 |
| | | addition (parts) | | | |
| | | Degree of | 95 | 95 | 92 |
| | | hydrophobicity (%) | | | |

| | | | | |
|---|---|---|---|---|
| | D1/D2 | 154 | 8 | 333 |
| | D2/D3 | 52.0 | 50.0 | 1.5 |
| Evaluation | Contrast | X(0.52) | X(0.68) | X(0.42) |
| | Minimum driving voltage | X(160 V) | X(120 V) | X(120 V) |
| | Repeatability | ◯ | ◯ | Δ |
| | Fixing rate (%) | 85 | 90 | 78 |

### REFERENCE SIGNS LIST

1: Base particles,
2: Resin fine particles,
3: Inorganic fine particles
10: Image display apparatus
11:12: Substrate
15: Electrode
16: Insulating layer
17: Partition wall
18: Gap
18a: Image display surface
21: Black display particles
22: White display particles

1. Display particles, which are used for an image display apparatus having a structure in which the display particles in a powdered state are sealed between two substrates at least one of which is transparent, and by generating an electric field between the substrates, the display particles are moved so that an image is displayed, comprising:
base particles A containing at least a resin and a colorant, and having a volume-average particle size D1 of 1 to 50 μm;
resin fine particles B being externally added to the base particles, and having an average primary particle size D2 of 30 to 250 nm; and
inorganic fine particles C being externally added to the base particles, and having an average primary particle size D3 of 5 to 30 nm,
wherein the display particles for an image display apparatus are designed so that D1, D2 and D3 satisfy the following formulae:
10≦D1/D2≦1000 (1)
2≦D2/D3≦50 (2).

2. The display particles of claim 1, wherein the resin fine particles B is contained at a content of 0.1 to 200 parts by weight relative to 100 parts by weight of the base particles.

3. The display particles of claim 1, wherein the inorganic fine particles C is contained at a content of 0.01 to 30 parts by weight relative to 100 parts by weight of the base particles.

4. The display particles of claim 1, wherein the display particles comprise positively charged display particles and negatively charged display particles, with any of the display particles being formed of the base particles A to which the resin fine particles B and the inorganic fine particles B are externally added.

5. An image display apparatus comprising the display particles of claim 1.

6. The display particles of claim 2, wherein the inorganic fine particles C is contained at a content of 0.01 to 30 parts by weight relative to 100 parts by weight of the base particles.

7. The display particles of claim 2, wherein the display particles comprise positively charged display particles and negatively charged display particles, with any of the display particles being formed of the base particles A to which the resin fine particles B and the inorganic fine particles B are externally added.

8. The display particles of claim 3, wherein the display particles comprise positively charged display particles and negatively charged display particles, with any of the display particles being formed of the base particles A to which the resin fine particles B and the inorganic fine particles B are externally added.

9. An image display apparatus comprising the display particles of claim 2.

10. An image display apparatus comprising the display particles of claim 3.

11. An image display apparatus comprising the display particles of claim 4.
